(19) United States
(12) Patent Application Publication
(10) Pub. No.: US 2017/0297188 A1
(43) Pub. Date: Oct. 19, 2017

(54) CLAMPING DEVICE FOR A NAIL GUN

(71) Applicant: EVERWIN PNEUMATIC CORP., Taichung City (TW)

(72) Inventors: Wen-Sheng Huang, Taichung City (TW); Wayne Chen, Taichung City (TW)

(21) Appl. No.: 15/099,601

(22) Filed: Apr. 15, 2016

(51) Int. Cl. B25C 7/00; B25C 1/04

(52) U.S. Cl. CPC B25C 7/00; B25C 1/04

(57) ABSTRACT

A clamping device comprises a fixing frame for assembling to a nail gun, a clamping arm pivoted to one side of the fixing frame and swung relative to a nail output of the nail gun connected to the fixing frame, a cylinder having a telescopic rod and linked to the clamping arm, and a pipeline fluidly communicated with the cylinder and a pneumatic supply. The fixing frame is fixed corresponding to the nail output so as to easily assemble and disassemble. An air pressure through the pipeline is driving the telescopic rod and the clamping arm to swing relative to the fixing frame. A lay-up is clamped by the clamping arm to abut against the nail output for nailing and piercing. It may be easily detached from the nail gun after finishing constructing so that the multiple functions of the nail gun may be achieved.

### BACKGROUND OF THE INVENTION

### 1. Field of the Invention

The present invention relates to a nail gun while being in the process of construction, and especially relates to a clamping device assembled to a nail gun.

### 2. Description of Related Art

The nail guns in the market are mainly provided for the uses in wood manufacturing industry, decorating materials industry, and decorating construction industry. Recently, the nail gun is made to form a specific structure for single use in order to process a specific construction.

Please reference to Taiwanese patent no. I440533, it disclosed a nail gun structure includes a gun body, a clamp set and a pneumatic driving set. The gun body has a trigger for shooting a nail. The clamp set is assembled with the gun body. The clamp set has a driven base and a clamp base. The clamp base pivots relative to the driven base. A stacked board is positioned on the clamp base. The pneumatic driving set is disposed between the gun body and the clamp set. The pneumatic driving set communicates with an air pressure source. The trigger moves along with the pneumatic driving set. Under this arrangement, when a user pulls the trigger, the pneumatic driving set drives the clamp base to pivot, so that the stacked boards are clamped between the clamp base and the driven base; thereafter, the nail is shot and nailed on the stacked board.

In the above mentioned structure, the clamp set and the pneumatic driving set are assembled to the gun body. The clamp set further includes a fixing plate and a connection rod. The fixing plate further includes a first assembling portion and a second assembling portion. An angle is angled between the first assembling portion and the second assembling portion. The first assembling portion is arranged on the gun body. The second assembling portion is assembled to one end of the driven base. One end of the connection rod is assembled to the stock of the gun body and the other end of the connection rod is assembled to the end of the driven base opposite to the second assembling portion.

The pneumatic driving set further includes a pneumatic valve, a first connection valve, a second connection valve, an adjusting valve, and a driving valve. The pneumatic valve is arranged at the fixing plate. The first connection valve is fluidly communicated between the gun body and the air pressure source. The first connection valve is connected to the pneumatic valve with a first pipeline. The second connection valve is connected between the pneumatic valve and the adjusting valve. The second connection valve is connected to the gun body with a second pipeline. The adjusting valve is connected to the gun body with a third pipeline. The driving valve is assembled to the driven base and connected to the pneumatic valve with a third pipeline. The driving valve is assembled on the driven base and connected to the pneumatic valve with a fourth pipeline so as to drive the clamp base the pivot and swing relative to the driven base.

However, as above mentioned structures, no matter what the clamp set or the pneumatic driving set is composed of many loose elements to form a complicated structure, once the loose elements are assembled to the nail gun, it is inconvenient to disassemble from the nail gun and the structure combined with the nail gun is hard to apply to other uses except construction of wooden pallets. The uses of the nail gun is limited. It is a first drawback thereof.

In order to provide for using in specific construction of wooden pallets, two complicated structures are assembled to the nail gun so that the heavy and complicated nail gun becomes more complicated. The difficulty and defective rate of assembling and manufacturing nail gun are increased. It is a second drawback thereof.

Because the clamp set and the pneumatic driving set which are complicated structures are assembled to the nail gun, the cost and price of each nail gun are increased higher so as not to be cost-effective. It is a third drawback thereof.

In view of the foregoing circumstances, the inventor has invested a lot of time to study the relevant knowledge, compare the pros and cons, research and develop related products. After quite many experiments and tests, the “clamping device for a nail gun” of this invention is eventually launched to improve the foregoing shortcomings, to meet the public use.

### SUMMARY OF THE INVENTION

A main object of this invention is providing a clamping device for a nail gun. The fixing frame may be easily assembled and disassembled to the nail gun. It may be detached from the nail gun easily after finishing nailing and piercing the lay-up but not to influence and limit the use of the nail gun in other technical fields. And multiple functions of the nail gun may be achieved.

Another object of this invention is providing a clamping device for a nail gun, It is effectively to prevent the nail gun 100 from resulting in complicated structure and heavy weight due to hanging many elements. It has the effects of light weight and low cost and price.

In order to achieve above mentioned objects, a clamping device for a nail gun comprises a fixing frame, a clamping arm, a cylinder, and a pipeline, wherein: the fixing frame is assembled to the nail gun; the clamping arm is pivoted to one side of the fixing frame and swung and pivoted relative to the fixing frame which is corresponding to a nail output of the nail gun; the cylinder has a telescopic rod linked the clamping arm; and the pipeline is fluidly communicated with the cylinder and a pneumatic supply of the nail gun, the pneumatic supply fluidly communicated with the pipeline is driving the telescopic rod and the clamping arm to swung and pivoted relative to the fixing frame, the clamping arm is clamped a lay-up to abut against the nail output to be pierced by a nail, and the pipeline is released an air pressure and the telescopic rod of the cylinder is driving the clamping arm to release the lay-up.

In some embodiments, the fixing frame further includes a cover portion, an upper fixing portion, and a lower fixing portion, the cover portion is arranged at one end of the fixing frame, the upper fixing portion is arranged at an upper part of one end of the fixing frame opposite to the cover portion, the lower fixing portion is arranged at an lower part of the end of the fixing frame opposite to the cover portion and corresponding to the upper fixing portion, the cover portion includes a cover slot for covering a head of the nail gun and a plurality of connection holes for fixing, the upper fixing portion includes a connection plate for connecting with a stock of the nail gun, and the lower fixing portion includes a pivoting rod.

In some embodiments, the clamping arm further includes a pivoting section, a driven section, and a clamping section, the pivoting section is pivoted to the pivoting rod of the lower fixing portion, the driven section and the clamping section are respectively arranged at corners of two ends of the pivoting section, the driven section is arranged between the upper fixing portion and the lower fixing portion, the clamping section is extended to the nail output of the nail gun and arranged with the fixing frame in parallel, the clamping section is connected to a nail stopping member, and the nail stopping member is corresponding to the nail output of the nail gun.

In some embodiments, the nail stopping member includes a lower connection portion, the clamping section has a covering hole and a fixing screw, the covering hole is connected with the lower connection portion, and the fixing screw is radially screwed in along the covering hole and abutted against the lower connection portion of the nail stopping member to fasten.

In some embodiments, the cylinder is connected to the upper fixing portion, one end of the telescopic rod toward the lower fixing portion is arranged a covering portion, the covering portion and an end portion of the driven section are linked and connected with each other, and one end of the telescopic rod inserted into the cylinder is arranged a driving piston.

In some embodiments, a return spring is covered the telescopic rod and arranged between the cylinder and the driving piston to drive the telescopic rod to contract in the cylinder so that the telescopic rod is linked and driven the clamping arm to release the lay-up.

In some embodiments, the pipeline further includes a control valve for controlling the air pressure, a valve rod, and an elastic member, the control valve has a valve chamber with an opening, an upper valve hole, and a lower valve hole, the upper valve hole and the lower valve hole are fluidly communicated with the valve chamber, the upper valve hole is fluidly communicated with the cylinder through the pipeline, the lower valve hole is fluidly communicated with the pneumatic supply through the pipeline, the valve chamber has an inner stopping ring and a pressure relief ring groove, the inner stopping ring is arranged between the upper valve hole and the lower valve hole, the pressure relief ring groove is arranged at the opening of the valve chamber, the valve rod is covered an upper sealant ring and a lower sealant ring which are sealed and abutted against an inner wall of the valve chamber, one end of the valve rod is plugged into the valve chamber so that the lower sealant ring is arranged at a lower side of the inner stopping ring and the other end of the valve rod opposite to the valve chamber is exposed to and protruded from the valve chamber, two ends of the elastic member are normally and elastically abutted against a close end which is closed by the valve rod and the valve chamber so that the lower sealant ring is abutted against the inner stopping ring to stop the air pressure to lead to the pneumatic supply and the upper sealant ring is corresponding to the pressure relief ring groove to release the air pressure in the pneumatic supply.

In some embodiments, the pipeline further includes a pressing handle, a center section of the pressing handle is pivoted to an outside of the cover portion of the fixing frame so that a lower end of the pressing handle is abutted against the end of the valve rod protruded from the valve chamber.

The various objects and advantages of the present invention will be more readily understood from the following detailed description when read in conjunction with the appended drawing.

### BRIEF DESCRIPTION OF THE DRAWINGS

FIG. 1 is an exploded view of a clamping device for a nail gun of the present invention;

FIG. 2 is a perspective view of the clamping device for the nail gun of the present invention;

FIG. 3 is a perspective view of the clamping device of the present invention while being assembled to a nail gun;

FIG. 4 is a view of the clamping device of the present invention while being assembled to the nail gun and worked with a lay-up;

FIG. 5 is a cross-sectional view of the clamping device of the present invention while being assemble to the nail gun;

FIG. 6 is an operational view of the clamping device of the present invention while clamping the lay-up;

FIG. 7 is a partial cross-sectional view of a control valve of the clamping device of the present invention;

FIG. 8 is another partial cross-sectional view of the control valve of the clamping device of the present invention;

FIG. 9 is an operational view of the clamping device for the nail gun of the present invention while the lay-up which is clamped is nailed to fix; and

FIG. 10 is an operational view of the clamping device for the nail gun of the present invention after the lay-up which is clamping is finished nailing to fix.

### DETAILED DESCRIPTION OF THE INVENTION

To describe clearly that the present invention achieves the foregoing object and function, the technical features and desired function are described with reference to a preferred embodiment and accompanying drawings.

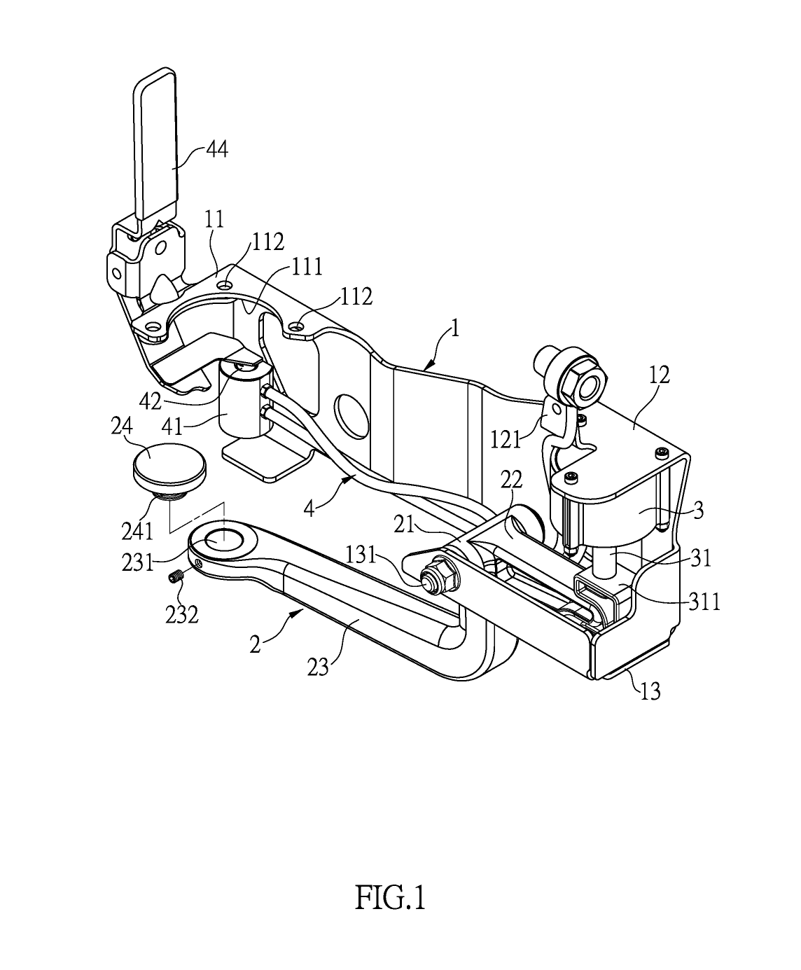

Please reference to FIGS. 1 to 9, a clamping device for a nail gun of the present invention may comprise a fixing frame 1, a clamping arm 2, a cylinder 3, and a pipeline 4. The fixing frame 1 is assembled to the nail gun 100. The nail gun 100 has a stock 101. A nail cartridge 102 is assembled to the nail gun 100. A plurality of strip-shaped nails is received in the nail cartridge 102. A head 103 and an nail output 108 protruded from the head 103 are arranged at a front end of the nail gun 100. An air chamber 104 is arranged in the nail fun 100 for providing compressed air to push a firing pin 105 to strike the nails 106 and then the nails 106 are shot from the nail output 108 after pulling a trigger 107 of the nail gun 100. (The operation of striking the nails for the nail gun 100 is known as prior art and they are shortly described only.) The clamping arm 2 is pivoted to one side of the fixing frame 1 and swung and pivoted relative to the fixing frame 1 which is corresponding to the nail output 108 of the nail gun 100. The cylinder 3 has a telescopic rod 31 which is linked the clamping arm 2. The pipeline 4 is fluidly communicated with the cylinder 3 and a pneumatic supply of the nail gun 100. The pneumatic supply fluidly communicated with the pipeline 4 is driving the telescopic rod 31 of the cylinder 3 and the clamping arm 2 to swung and pivoted relative to the fixing frame 1. The clamping arm 2 is clamped a lay-up to abut against the nail output 108 to be pierced by the nail(s). The pipeline 4 is released an air pressure and the telescopic rod 31 of the cylinder 3 is driving the clamping arm 2 to release the lay-up 200.

The above mentioned embodiment is the main skill feature of this invention and corresponds to the claim 1 of this invention to understand the object and embodiments of this invention in detail. And the skill features of the depending claims are for describing the claim 1 in detail or adding more skill features, but not limited thereto. It should be known that the claim 1 is not necessary to include the skill features of the depending claims.

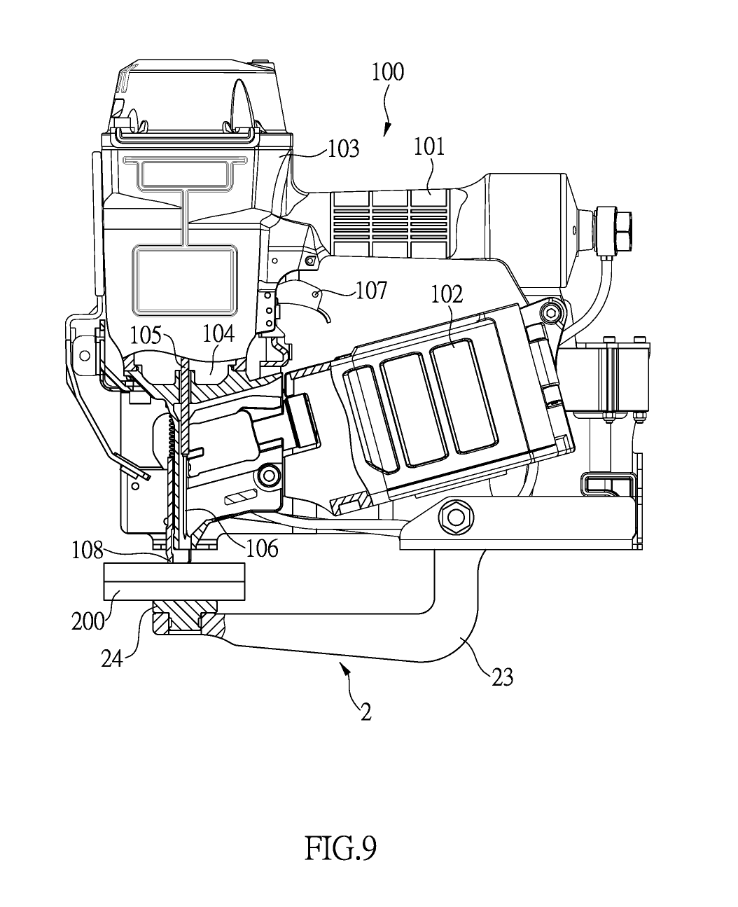

In FIG. 9, the fixing frame 1 further includes a cover portion 11, an upper fixing portion 12, and a lower fixing portion 13. The cover portion 11 is arranged at one end of the fixing frame 1. The upper fixing portion 12 is arranged at an upper part of one end of the fixing frame 1 opposite to the cover portion 11. The lower fixing portion 13 is arranged at an lower part of the end of the fixing frame 1 opposite to the cover portion 11 and corresponding to the upper fixing portion 12. The cover portion 11 includes a cover slot 111 for covering the head 103 of the nail gun 100 and a plurality of connection holes 112 for fixing. The upper fixing portion 12 includes a connection plate 121 for connecting with the stock 101 of the nail gun 100. The lower fixing portion 13 includes a pivoting rod 131. The clamping arm 2 further includes a pivoting section 21, a driven section 22, and a clamping section 23. The pivoting section 21 is pivoted to the pivoting rod 131 of the lower fixing portion 13. The driven section 22 and the clamping section 23 are respectively arranged at corners of two ends of the pivoting section 21. The driven section 22 is arranged between the upper fixing portion 12 and the lower fixing portion 13. The clamping section 23 is extended to the nail output 108 of the nail gun 100 and arranged with the fixing frame 1 in parallel. The clamping section 23 is connected to a nail stopping member 24. The nail stopping member 24 is corresponding to the nail output 108 of the nail gun 100. The nail stopping member 24 includes a lower connection portion 241. The clamping section 23 has a covering hole 231 and a fixing screw 232. The covering hole 231 is connected with the lower connection portion 241. The fixing screw 232 is radially screwed in along the covering hole 231 and abutted against the lower connection portion 241 of the nail stopping member 24 to fasten. The cylinder 3 is connected to the upper fixing portion 12. One end of the telescopic rod 31 toward the lower fixing portion 13 is arranged a covering portion 311. The covering portion 311 and an end portion of the driven section 22 are linked and connected with each other. One end of the telescopic rod 31 inserted into the cylinder 3 is arranged a driving piston 312. A return spring 313 is covered the telescopic rod 31 and arranged between the cylinder 3 and the driving piston 312 to drive the telescopic rod 31 to contract in the cylinder 3 so that the telescopic rod 31 is linked and driven the clamping arm 2 to release the lay-up 200. In addition, the pipeline 4 further includes a control valve 41 for controlling the air pressure, a valve rod 42, and an elastic member 43. The control valve 41 has a valve chamber 411 with an opening, an upper valve hole 412, and a lower valve hole 413. The upper valve hole 412 and the lower valve hole 413 are fluidly communicated with the valve chamber 411. The upper valve hole 412 is fluidly communicated with the cylinder 3 through the pipeline 4. The lower valve hole 413 is fluidly communicated with the pneumatic supply through the pipeline 4. The valve chamber 411 has an inner stopping ring 414 and a pressure relief ring groove 415. The inner stopping ring 414 is arranged between the upper valve hole 412 and the lower valve hole 413. The pressure relief ring groove 415 is arranged at the opening of the valve chamber 411. The valve rod 42 is covered an upper sealant ring 422 and a lower sealant ring 423 which are sealed and abutted against an inner wall of the valve chamber 411. One end of the valve rod 42 is plugged into the valve chamber 411 so that the lower sealant ring 423 is arranged at a lower side of the inner stopping ring 414 and the other end of the valve rod 42 opposite to the valve chamber 411 is exposed to and protruded from the valve chamber 411. Two ends of the elastic member 43 are normally and elastically abutted against a close end which is closed by the valve rod 42 and the valve chamber 411 so that the lower sealant ring 423 is abutted against the inner stopping ring 414 to stop the air pressure to lead to the pneumatic supply and the upper sealant ring 422 is corresponding to the pressure relief ring groove 415 to release the air pressure in the pneumatic supply. Finally, the pipeline 4 further includes a pressing handle 44. A center section of the pressing handle 44 is pivoted to an outside of the cover portion 11 of the fixing frame 1 so that a lower end of the pressing handle 44 is abutted against the end of the valve rod 42 protruded from the valve chamber 411.

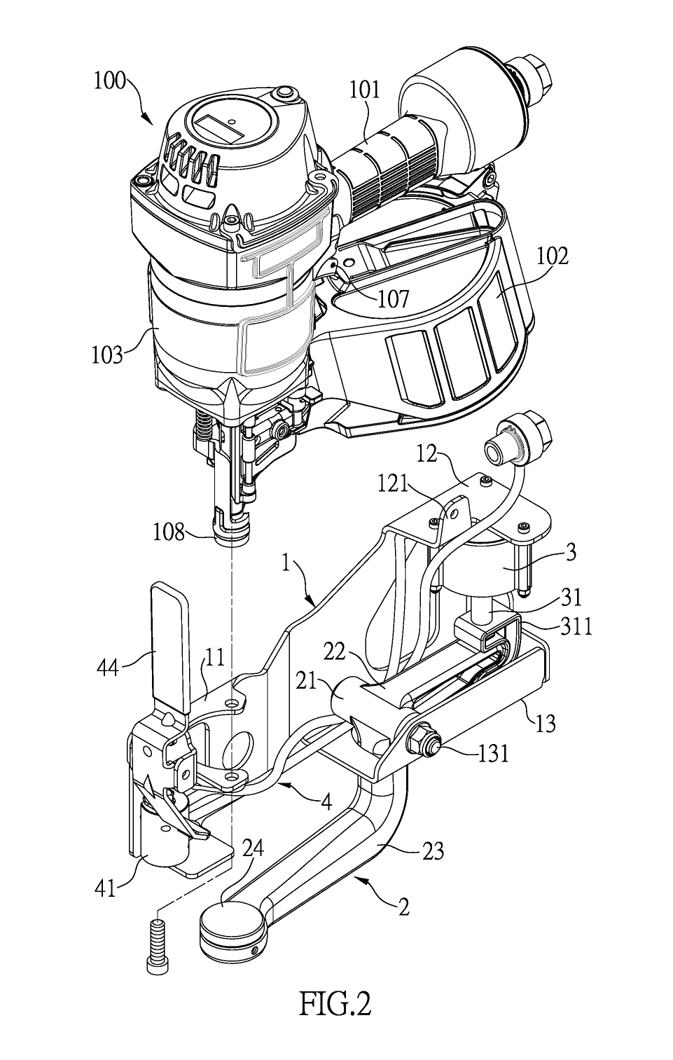

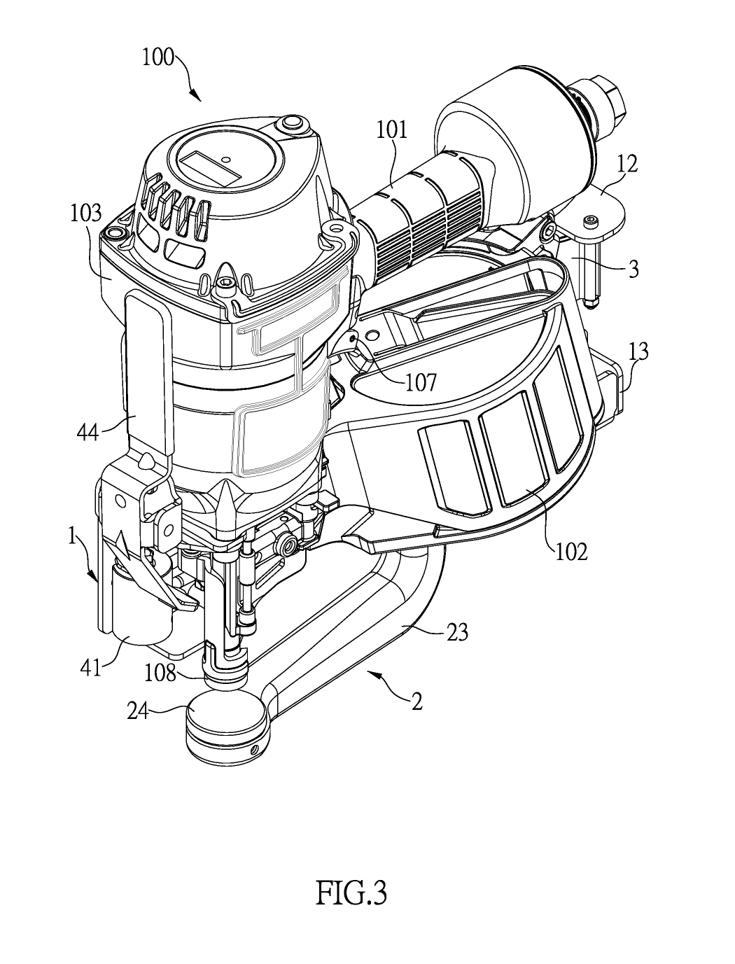

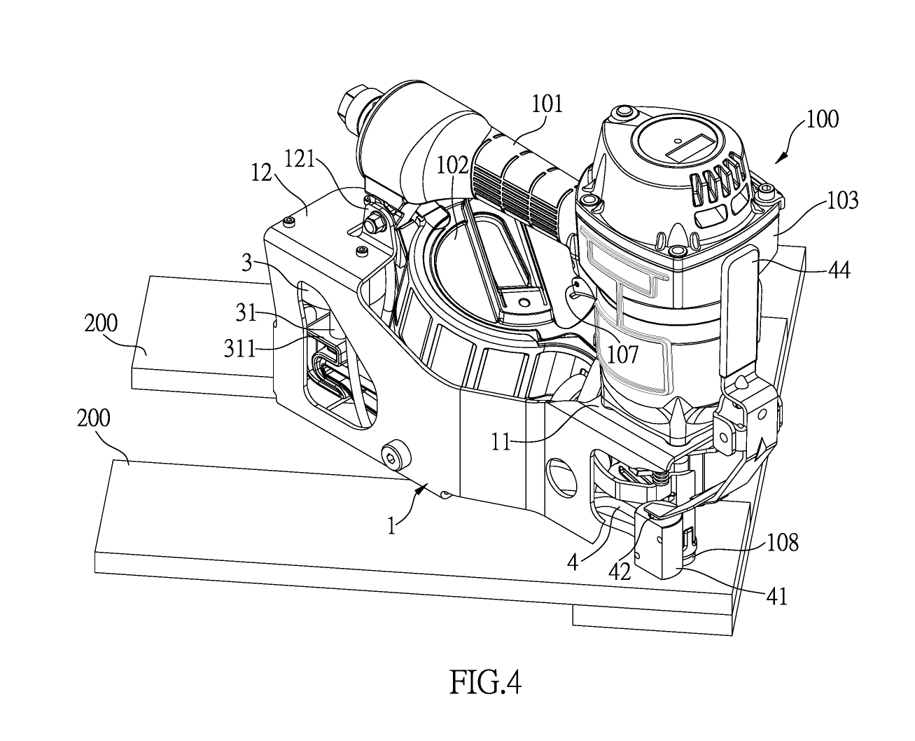

In FIGS. 2 and 3, the clamping device of the present invention is connected to the head 103 of the nail gun 100 with the cover slot 111 of the cover portion 11 arranged at one end of the fixing frame 1 and the connection holes 112 and connected to the stock 101 of the nail gun 100 with the connection plate 121 of the upper fixing portion 12 arranged at the other end of the fixing frame 1. It may be assembled to the nail gun 100 quickly to clamp the lay-up 200 and fixed corresponding to the nail output 108 of the nail gun 100. In FIG. 4, the nail gun 100 may be assisted to quickly align with the lay-up 200 to nail for fixing and assembling and multiple functions may be achieved. The fixing frame 1 and the nail gun 100 may be detached and returned to the status as in FIG. 2 but not to influence and limit the use of the nail gun 100 in other technical fields after nailing and piercing.

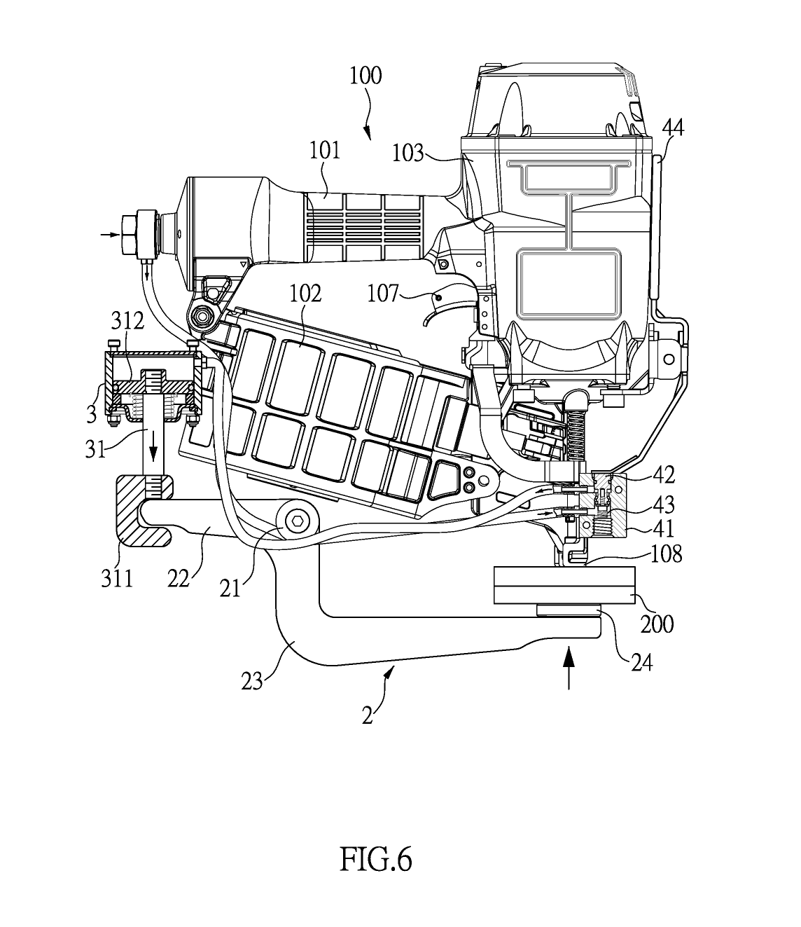

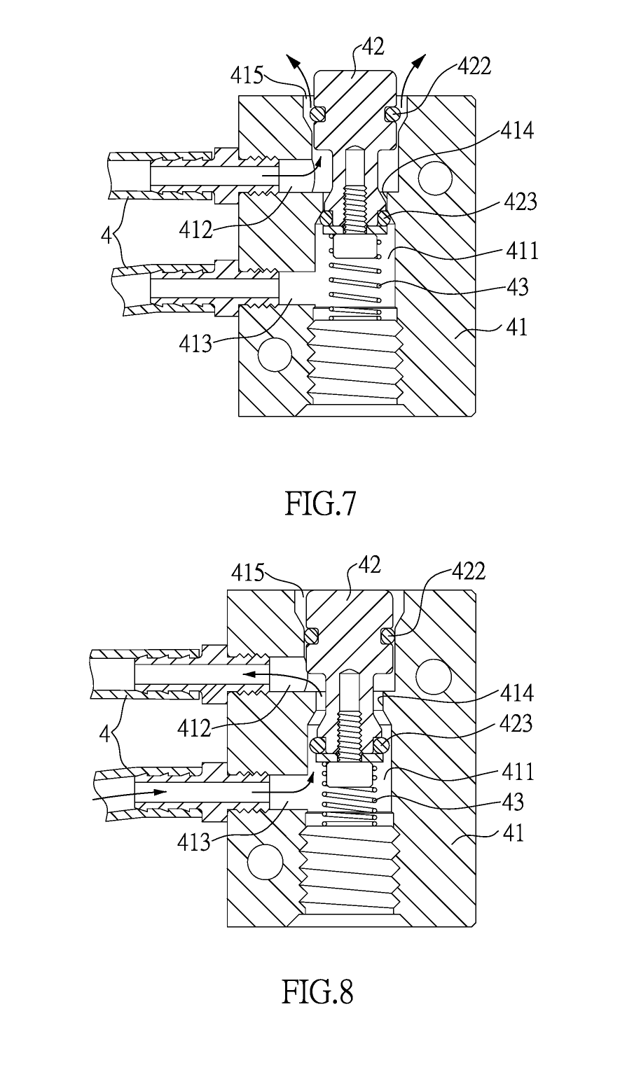

Please refer to FIGS. 6 to 8, in FIG. 7, the valve rod 42 is plugged in the valve chamber 411 of the control valve 41 so that the lower sealant ring 423 is arranged at the lower side of the inner stopping ring 414. The lower sealant ring 423 is abutted against the inner stopping ring 414 with the elastic member 43 to stop the air pressure to lead to the cylinder 3. And the upper sealant ring 422 is corresponding to the pressure relief ring groove 415 to release the air pressure in the cylinder 3. When an upper end of the pressing handle 44 is turned to make a lower end of the pressing handle 44 press the valve rod 42 downwardly, the valve rod 42 is pressed downwardly to compress the elastic member 43 so that the lower sealant ring 423 may leave the inner stopping ring 414. As the direction shown by the arrow in FIGS. 6 and 8, the air pressure led connected with the pipeline 4 is led to the cylinder 3 to drive the telescopic rod 31 and clamping arm 2 to swing and pivot relative to the fixing frame 1 with the covering portion 311. And then, the clamping arm 2 may be clamped the lay-up 200 to abut against the nail output 108 so as to next operation of nailing.

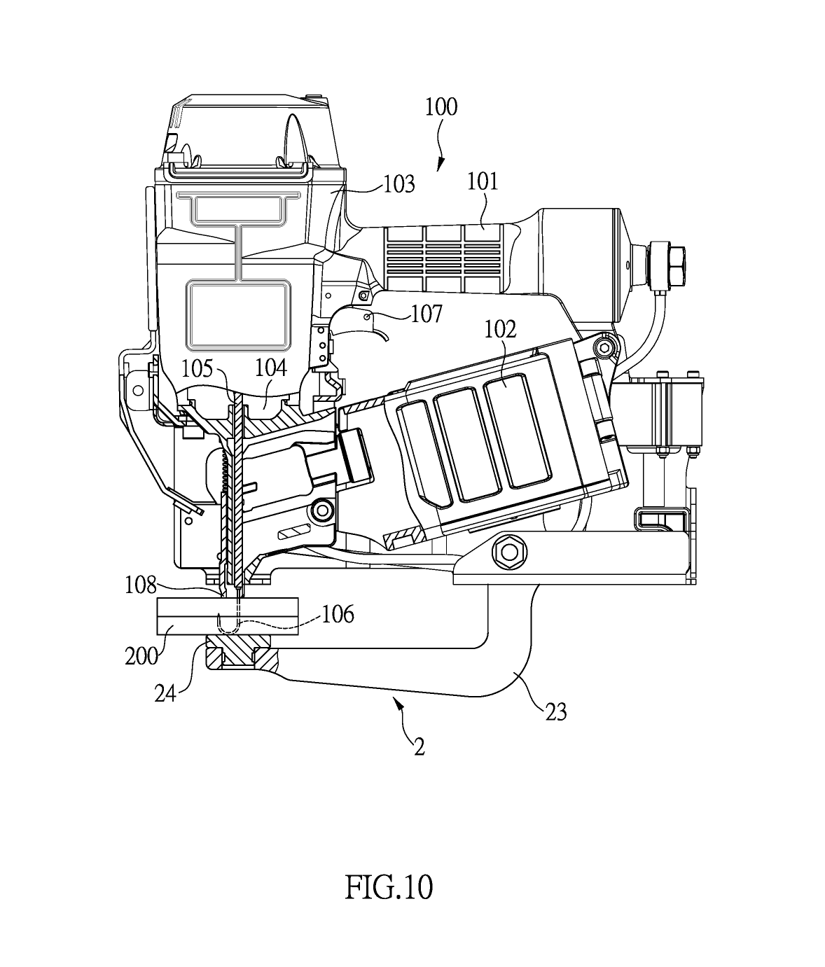

FIG. 9 is an operational view of the clamping device for the nail gun of the present invention while the lay-up which is clamped is nailed to fix. After the trigger 107 of the nail gun 100 used in the present invention is pulled, the firing pin 105 is pushed by the air compressed in the air chamber 104 and the firing pin 105 is stricken the nails 106 to shoot from the nail output 108 to pierce the lay-up 200 clamped by the clamping arm 2. Because the clamping section 23 of the clamping arm 2 is connected with the nail stopping member 24 corresponding to the nail output 108 of the nail gun 100, a sharp end of the nail 106 pierced the lay-up 200 is stricken the ail stopping member 24 to turn and bend shown as in FIG. 10 so that a tail end of the nail 106 is formed a barb shape so as not to protrude from the lay-up 200 to prevent from dangers.

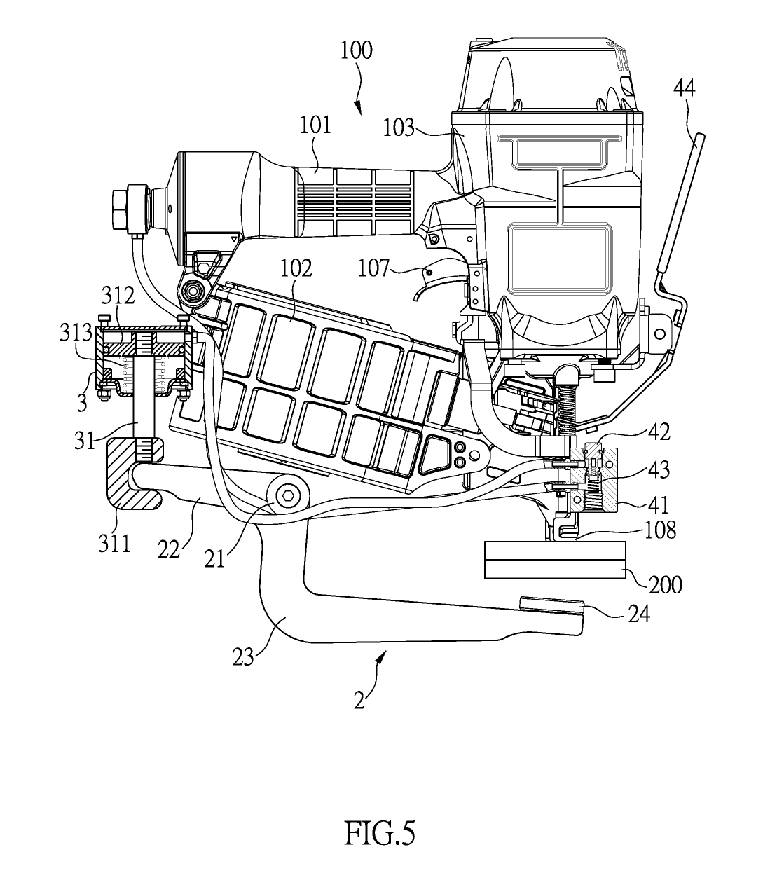

Please refer to FIGS. 5 and 7, the upper end of the pressing handle 44 is turned in opposite direction so that the lower end of the pressing handle 42 may leave the valve rod 42. The elastic member 43 may elastically lift the valve rod 42 so that the lower sealant ring 423 is abutted against the inner stopping ring 414 to stop the air pressure to lead to the cylinder 3. As the direction shown by the arrow in FIG. 7, the upper sealant ring 422 is arranged corresponding to the pressure relief ring groove 415 to release the air pressure in the cylinder 3. The return spring 313 which is covered the telescopic rod 31 and arranged between the cylinder 3 and the driving piston 312 is driving the telescopic rod 31 to contract in the cylinder 3. The telescopic rod 31 is driving the clamping arm 2 to leave and release the lay-up 200 with the covering portion 311 so as to leave the lay-up 200 which is finished nailing for fixing. The fixing frame 1 and the nail gun 100 may be detached and returned to the status as in FIG. 2 but not to influence and limit the use of the nail gun 100 in other technical fields after nailing and piercing.

As above mentioned, the cover portion 11 arranged at one end of the fixing frame 1 is connected to the head 103 of the nail gun 100 and the connection plate 121 of the upper fixing portion 12 arranged at the other end of the fixing frame 1 is connected to the stock 101 of the nail gun 100. It may be quickly assembled to the nail gun 100 to clamp the lay-up 200 and easily disassembled. The drawbacks of the recent nail gun may be improved. The advantages of the clamping device for the nail gun of the present invention may be described as follows.

Firstly, the fixing frame 1 may be easily assembled and disassembled to the nail gun 100. It may be detached from the nail gun 100 easily after finishing nailing and piercing the lay-up 200 but not to influence and limit the use of the nail gun 100 in other technical fields. And multiple functions of the nail gun 100 may be achieved.

Secondly, it is effectively to prevent the nail gun 100 from resulting in complicated structure and heavy weight due to hanging many elements. It has the effects of light weight and low cost and price.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A clamping device for a nail gun, comprising a fixing frame, a clamping arm, a cylinder, and a pipeline, wherein:
the fixing frame is assembled to the nail gun;
the clamping arm is pivoted to one side of the fixing frame and swung and pivoted relative to the fixing frame which is corresponding to a nail output of the nail gun;
the cylinder has a telescopic rod linked the clamping arm; and
the pipeline is fluidly communicated with the cylinder and a pneumatic supply of the nail gun, the pneumatic supply fluidly communicated with the pipeline is driving the telescopic rod and the clamping arm to swung and pivoted relative to the fixing frame, the clamping arm is clamped a lay-up to abut against the nail output to be pierced by a nail, and the pipeline is released an air pressure and the telescopic rod of the cylinder is driving the clamping arm to release the lay-up.

2. The clamping device as claimed in claim 1, wherein the fixing frame further includes a cover portion, an upper fixing portion, and a lower fixing portion, the cover portion is arranged at one end of the fixing frame, the upper fixing portion is arranged at an upper part of one end of the fixing frame opposite to the cover portion, the lower fixing portion is arranged at an lower part of the end of the fixing frame opposite to the cover portion and corresponding to the upper fixing portion, the cover portion includes a cover slot for covering a head of the nail gun and a plurality of connection holes for fixing, the upper fixing portion includes a connection plate for connecting with a stock of the nail gun, and the lower fixing portion includes a pivoting rod.

3. The clamping device as claimed in claim 2, wherein the clamping arm further includes a pivoting section, a driven section, and a clamping section, the pivoting section is pivoted to the pivoting rod of the lower fixing portion, the driven section and the clamping section are respectively arranged at corners of two ends of the pivoting section, the driven section is arranged between the upper fixing portion and the lower fixing portion, the clamping section is extended to the nail output of the nail gun and arranged with the fixing frame in parallel, the clamping section is connected to a nail stopping member, and the nail stopping member is corresponding to the nail output of the nail gun.

4. The clamping device as claimed in claim 3, wherein the nail stopping member includes a lower connection portion, the clamping section has a covering hole and a fixing screw, the covering hole is connected with the lower connection portion, and the fixing screw is radially screwed in along the covering hole and abutted against the lower connection portion of the nail stopping member to fasten.

5. The clamping device as claimed in claim 3, wherein the cylinder is connected to the upper fixing portion, one end of the telescopic rod toward the lower fixing portion is arranged a covering portion, the covering portion and an end portion of the driven section are linked and connected with each other, and one end of the telescopic rod inserted into the cylinder is arranged a driving piston.

6. The clamping device as claimed in claim 5, wherein a return spring is covered the telescopic rod and arranged between the cylinder and the driving piston to drive the telescopic rod to contract in the cylinder so that the telescopic rod is linked and driven the clamping arm to release the lay-up.

7. The clamping device as claimed in claim 1, wherein the pipeline further includes a control valve for controlling the air pressure, a valve rod, and an elastic member, the control valve has a valve chamber with an opening, an upper valve hole, and a lower valve hole, the upper valve hole and the lower valve hole are fluidly communicated with the valve chamber, the upper valve hole is fluidly communicated with the cylinder through the pipeline, the lower valve hole is fluidly communicated with the pneumatic supply through the pipeline, the valve chamber has an inner stopping ring and a pressure relief ring groove, the inner stopping ring is arranged between the upper valve hole and the lower valve hole, the pressure relief ring groove is arranged at the opening of the valve chamber, the valve rod is covered an upper sealant ring and a lower sealant ring which are sealed and abutted against an inner wall of the valve chamber, one end of the valve rod is plugged into the valve chamber so that the lower sealant ring is arranged at a lower side of the inner stopping ring and the other end of the valve rod opposite to the valve chamber is exposed to and protruded from the valve chamber, two ends of the elastic member are normally and elastically abutted against a close end which is closed by the valve rod and the valve chamber so that the lower sealant ring is abutted against the inner stopping ring to stop the air pressure to lead to the pneumatic supply and the upper sealant ring is corresponding to the pressure relief ring groove to release the air pressure in the pneumatic supply.

8. The clamping device as claimed in claim 7, wherein the pipeline further includes a pressing handle, a center section of the pressing handle is pivoted to an outside of the cover portion of the fixing frame so that a lower end of the pressing handle is abutted against the end of the valve rod protruded from the valve chamber.
